(19) United States
(12) Patent Application Publication
(10) Pub. No.: US 2026/0228860 A1
(43) Pub. Date: Aug. 6, 2026

(54) ARTIFICIAL INTELLIGENCE CUSTOMIZED DESIGN OF IMAGES

(71) Applicant: XEROX CORPORATION, NORWALK, CT (US)

(72) Inventors: Ron E. DUFORT, Rochester, NY (US); Dara N. LUBIN, Pittsford, NY (US); Elizabeth L. BARRESE, Penfield, NY (US); Matthew J. OCHS, Webster, NY (US)

(73) Assignee: XEROX CORPORATION, NORWALK, CT (US)

(21) Appl. No.: 19/042,192

(22) Filed: Jan. 31, 2025

(51) Int. Cl. G06T 5/60

(52) U.S. Cl. CPC G06T 5/60; G06T 2207/20021

(57) ABSTRACT

System and method for analyzing images, such as, for example, but not limited to, photographs, suggesting characteristics such as, for example, color palettes or themes, and enhancing the images, are used to produce a customized design. Images are received by the system and interrogated by an AI engine to provide a range of characteristic for, for example, the background and graphics that complement and enhance the image. The resolution of characteristic determination can be controlled. The system can receive a set of images, possibly related to each other, and locate images that are similar to the received image or set of images.

### TECHNICAL FIELD

The present disclosure relates to the field of customized photography. More specifically, the disclosure relates to methods and systems for using artificial intelligence to create customized color design of images such as photographs.

### BACKGROUND

Customized short-run printing and social media designs for device screens are a growing market. When creating a designed piece using personal photographs, such as holiday cards or invitations, the user chooses a theme and color preference first, then uploads the photographs. Then the user toggles through different layouts and switches backgrounds and themes, eventually choosing by trial and error a color palette and design. In some cases, the UI on the website provides a canned layout or premade color design based on the number of people or other objects in the photographs. Presently, the user is very limited to a few established color palettes, designs, and themes that have been chosen for them, and which are identical across the country.

In some systems, a feature allows consumer-driven decisions to refine the color palette by selecting words that match a mood. In U.S. Pat. No. 8,660,355, methods and systems for determining image processing operations relevant to particular imagery are described and include analyzing image parameters and applying them to images on a smartphone. U.S. Published Patent Application #2024/0004926 describes proactive creation of image-based products that recognize objects in an image and automatically select a style based on a predetermined library of styles and layouts. Metadata are used to perform the classification and provide suggestions.

What is needed is a system that (1) uses artificial intelligence (AI) to analyze images and learn over time how users modify their images, and (2) uses user preferences, evolving trends, and new sources of information to (3) automatically suggest photographic enhancements. What is needed is a system that uses AI to interrogate, using, for example, but not limited to, contextual clues within an image, the object in the photograph and the color of the objects. What is needed is a system that enables learning to guide recommendations to predict customer preferences. What is needed is a system in which a user's experience varies with, for example, but not limited to, geography, color trends, ethnic holidays, trends. What is needed is a larger array of choices compared to premade layouts and color themes. What is needed is a way to use AI to provide dynamic enhancement assistance, enabling a commercial printer to provide a customized experience for the user.

### SUMMARY

According to aspects described herein, systems and methods for analyzing images, such as, for example, but not limited to, photographs, suggesting characteristics such as, for example, color palettes or themes, and enhancing the images, are used to produce a customized design. Images are received by the system and interrogated by an AI engine. The system recognizes general characteristics such as, for example, but not limited to, occasions, by matching occasion images, such as, for example, but not limited to, graduation mortar boards or holiday sweaters. For example, the system uses AI to interrogate the image and provide a range of colors for the background and graphics that complement and enhance the colors and tones in the photograph. In some configurations, the user controls the resolution of characteristic matching, for example, but not limited to, with a slider that controls a grid resolution over the image. The system uses AI to provide, for example, but not limited to, a color palette and designs that can change relative to, for example, but not limited to, color trends, geographical preferences, and the user's past preferences. In some configurations, a user interface feature receives a color palette. In some configurations, the system uses theories related to the sciences of, for example, but not limited to, color and psychology, to provide suggested characteristics such as color pallets. The system is not limited to receiving a single image, but can receive a set of images, possibly related to each other. The system can also locate images that are similar to the received image or set of images, for example, similar in content, and/or color, and/or visually similar to a chosen template. Such a capability enables images to be added to a chosen design.

When the characteristic is color, in some configurations, color palettes can include, but are not limited to including, elemental, advancing, complementary, recede, tonal theme match, fluorescent and shiny. An elemental color palette uses items in the photo, such as the color of a tassel or gown, the design of a holiday sweater, to pick out and match for other graphical design elements. An advancing color palette uses elements of color theory described by Albers's “The Interaction of Color,” whereby the suggested color, being adjacent to the photo, will move forward and outward to the eye, and furthermore, interact with some elements in the photograph so the eye will also perceive them as brought forward. A complementary color palette uses elements that are the opposite of the prominent colors in the photo, to provide high contrasts. A recede color palette uses Albers'Theory whereby the suggested color, being adjacent to the photo, will move backward and away from the eye, and furthermore interact with some elements in the photograph so the eye will also perceive them as moving away. A tonal theme match color palette uses the dominant colors from the photograph and suggests darker and lighter tints of the same color, for example, to produce a quiet, harmonious composition. A fluorescent and shiny color palette uses colors like fluorescent yellow or pink, gold, and silver, and white or clear are included to enhance the background and graphics.

In some configurations, the user interface for characteristic selection includes displaying a grid that overlays the photo. The user interface can include a slider to adjust the sensitivity of the grid, from the outer edges of the photograph to precise targeting within the edges of the photograph, which can change AI suggestions. The system analyzes photographs by using AI and, for example, but not limited to, the metadata about the photographs, a user's preferences, color trends, design trends, and cultural and geographic contextual clues, and provides characteristics such as, for example, a color palette and design based on color theory, which changes dynamically based on geographic preferences, relevant holidays, user's previous preferences, among other factors. The system provides a customized, tailored experience based on the photographs, and the experience can be extended to print media and social media. The system reduces trial and error involved in graphic design, and may be accomplished in the absence of a professional design evaluation.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for enhancing characteristics associated with an image. The method includes receiving the image, and applying a grid to the image. The size of the grid can be based on a chosen resolution for determining the characteristics. The method also includes analyzing the image using an artificial intelligence (AI) engine. The AI engine can be trained to identify image elements in the grid cells in the image, determine the characteristics of the identified image elements, select enhancements to the image based on the characteristics, and filter the enhancements based on the identified image elements. The method also includes providing a list of the filtered enhancements for the grid cells, receiving selections from the list, and enhancing the grid cells based on the selections. Other embodiments of this aspect include corresponding computer systems, apparatus, and computer programs recorded on one or more computer storage devices, each configured to perform the actions of the methods.

Implementations may include one or more of the following features. The enhancements may include one or more of color, background, or graphics. The color can be chosen from a color palette that may include elemental, advancing, complementary, recede, tonal theme match, fluorescent and shiny. The method may include using elements of color theory to suggest the color palette, using the elements that are dominant in the image to suggest the color palette, and/or using the elements that are opposite of prominent colors in the image to suggest the color palette. The image may include a set of the images. The AI engine can be trained to recognize an occasion. The method may include selecting the chosen resolution using a slider. Implementations of the described techniques may include hardware, a method or process, or computer software on a computer-accessible medium.

One general aspect includes a computer system for enhancing characteristics associated with an image. The computer system includes a hardware processor, and a non-volatile storage medium storing instructions that when executed by the hardware processor perform operations. The operations may include receiving the image, and applying a grid to the image. The size of the grid can be based on a chosen resolution for determining the characteristics. The operations can include analyzing the image using an AI engine. The AI engine can be trained to identify image elements in the grid cells in the image, determine the characteristics of the identified image elements, select enhancements to the image based on the characteristics, and filter the enhancements based on the identified image elements. The operations can include providing a list of the filtered enhancements for the grid cells, receiving selections from the list, and enhancing the grid cells based on the selections. Other embodiments of this aspect include corresponding computer systems, apparatus, and computer programs recorded on one or more computer storage devices, each configured to perform the actions of the methods.

Implementations may include one or more of the following features. The enhancements may include one or more of color, background, or graphics. The color can be chosen from a color palette that may include elemental, advancing, complementary, recede, tonal theme match, fluorescent and shiny. The operations may include using elements of color theory to suggest the color palette, using the elements that are dominant in the image to suggest the color palette, and/or using the elements that are opposite of prominent colors in the image to suggest the color palette, selecting the chosen resolution using a slider. The image may include a set of the images. The AI engine can be trained to recognize an occasion. Implementations of the described techniques may include hardware, a method or process, or computer software on a computer-accessible medium.

One general aspect includes a computer program product for enhancing characteristics associated with an image. The computer program product includes a computer readable storage medium having program instructions embodied therewith. The program instructions are executable by a computing device to cause the computing device to perform operations including receiving the image, and applying a grid to the image. The size of the grid can be based on a chosen resolution for determining the characteristics. The operations also include analyzing the image using an AI engine, where the AI engine is trained to identify image elements in the grid cells in the image, determine the characteristics of the identified image elements, select enhancements to the image based on the characteristics, and filter the enhancements based on the identified image elements. The operations include providing a list of the filtered enhancements for the grid cells, receiving selections from the list, and enhancing the grid cells based on the selections. Other embodiments of this aspect include corresponding computer systems, apparatus, and computer programs recorded on one or more computer storage devices, each configured to perform the actions of the methods.

Implementations may include one or more of the following features. The image includes a set of the images, and the AI engine is trained to recognize an occasion. Implementations of the described techniques may include hardware, a method or process, or computer software on a computer-accessible medium.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended as an example, and illustrates embodiments of devices, systems, and processes in accordance with the subject matter as claimed herein. The patent or application file contains at least one drawing executed in color. Copies of this patent or patent application publication with color drawing(s) will be provided by the Office upon request and payment of the necessary fee.

FIGS. 1A and 1B are photographic images of a method in accordance with embodiments of the present disclosure;

FIG. 2 is a photographic image of characterizing grid elements of a photograph in accordance with embodiments of the present disclosure;

FIG. 3 is a tabular mapping of the grid elements of FIG. 2 with their color components;

FIG. 4 is a photographic image of various frames selected for the image of FIG. 2 in accordance with embodiments of the present disclosure;

FIG. 5 is a photographic image of characterizing a higher resolution grid elements of the photograph of FIG. 2 in accordance with embodiments of the present disclosure;

FIG. 6 is a tabular mapping of the grid elements of FIG. 5 to their color components;

FIG. 7 is a photographic image of various frames selected for the image of FIG. 5 in accordance with embodiments of the present disclosure;

FIG. 8 is a schematic block diagram of a system for analyzing photographs, suggesting, for example, but not limited to, characteristics and/or themes, and enhancing the photographs to produce a customized design in accordance with embodiments of the present disclosure; and

FIG. 9 is a flowchart of a method for analyzing photographs, suggesting, for example, but not limited to, characteristics and/or themes, and enhancing the photographs to produce a customized design in accordance with embodiments of the present disclosure.

### DETAILED DESCRIPTION

Configurations are described to illustrate the disclosed subject matter, not to limit its scope, which is defined by the claims. Those of ordinary skill in the art will recognize a number of equivalent variations of the various features provided in the description herein.

The present disclosure describes methods and systems for providing customized photographic enhancement.

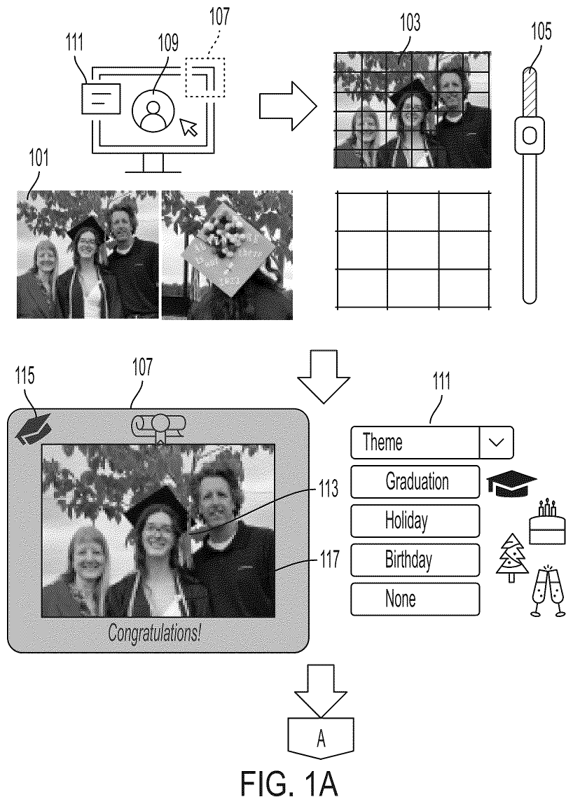

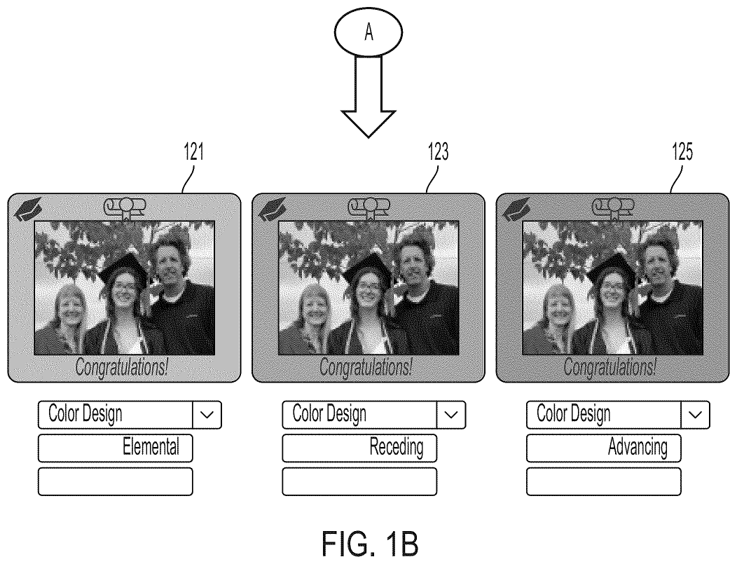

Referring now to FIG. 1A, as a first step in a method in accordance with embodiments of the present disclosure, a photograph 101 is uploaded to the system. In some configurations, characteristics such as color regions 103 in the photograph 101 are interrogated at a granularity level that can be, for example, (1) selected by a user using, for example, but not limited to, a slider 105, (2) determined automatically by the system, or (3) can be a default value. The color regions 103 are matched in the photograph with colors in a color palette to provide, for example, but not limited to, a border 107, a background 109, a theme 111, or another design element. Preferences for the color regions can be, for example, but not limited to, user-selected options, determined by the system, default values, previous preferences, the time of year, or items in the photograph. For example, the user can select a theme 111 from graduation, a holiday, a birthday, or other theme. The system can, for example, select the color of the background 109 to match the color of the tassel 113 and the robe element 117. The system can provide a mortarboard 115 in the background 109 to illustrate the selected theme 111 of graduation.

Referring now to FIG. 1B, in some configurations, the user can select from characteristics such as, for example, color theories such as, for example, but not limited to elemental 121, receding 123, advancing 125, complementary (not shown), or tonal (not shown). In some configurations, the user can choose from color design themes that are learned from the environment such as, for example, but not limited to, typical trends, colors of the year, or regional trends. The design can be saved and used for printing, screen device display, or other use.

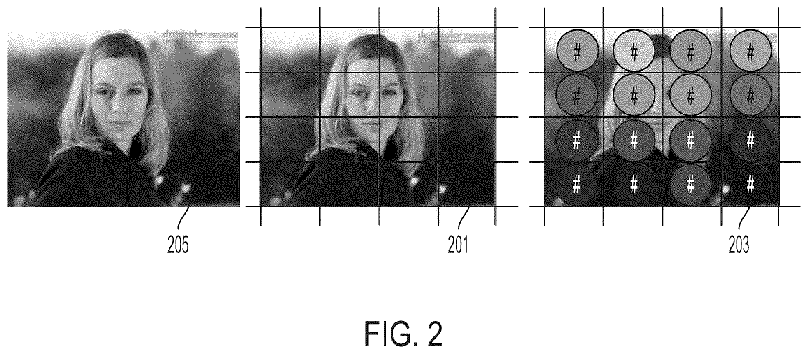

Referring now to FIG. 2, in an example in which the characteristic is color, a grid 201 is overlain on the photograph 205, and an average color 203 is determined for the elements of the grid 201. For example, the grid 201 can include a 4×4 matrix having sixteen grid elements. An average color 203 for the photograph can be determined, or for sections of the photograph.

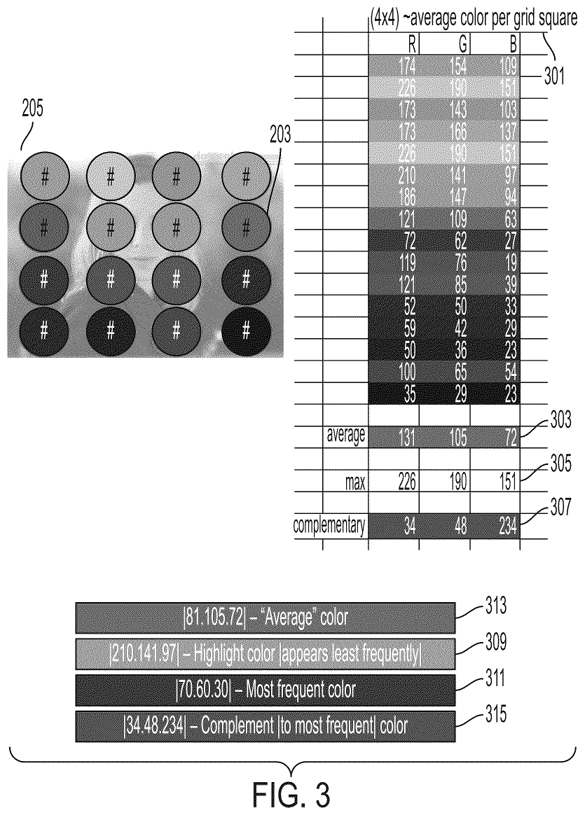

Referring now to FIG. 3, the grid element average colors 203 in the photograph of FIG. 2 are shown in a table 301 that provides, for example, but not limited to, red, green, and blue color components, the average 303 red, green, and blue color values over the photograph 205, the maximum 305 red, green, and blue color values in the photograph 205, and the complementary 307 red, green, and blue color values in the photograph 205. The system also provides the average color 313, the highlight color 309 that appears less frequently, the most frequent color 311, and the complement 315 to the most frequently appearing color in the photograph 205.

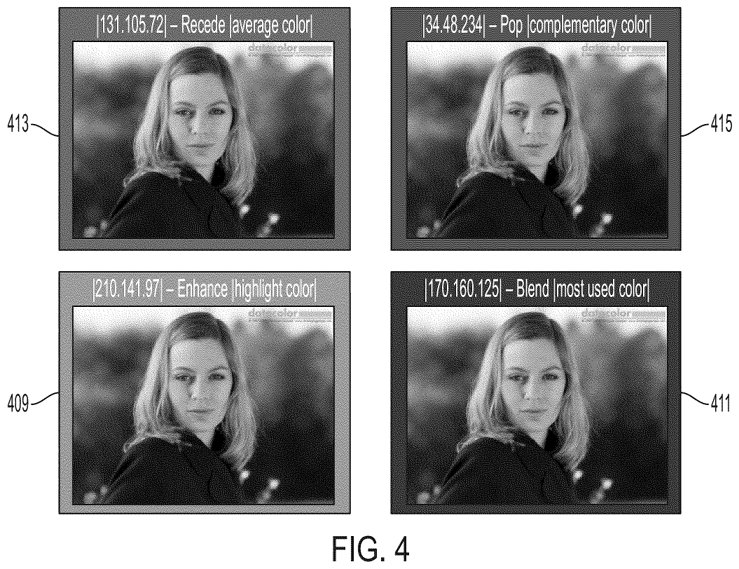

Referring now to FIG. 4, the photograph 205 is shown with borders of different colors, specifically the average color 413, the complementary color 415, the highlight color 409, and the most used color 411. The border can change the perception of the subject of the photograph 205. Using principles described in Albers'Theory of Interaction of Color, the border colors can make the subject recede (average color 413), pop (complementary color 415), enhance (highlight color 409), or blend (most used color 411), for example.

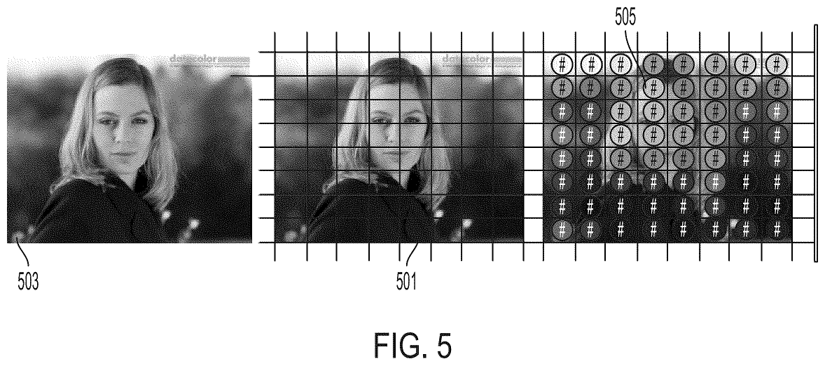

Referring now to FIG. 5, similar to high/low pass frequency filters, grid element size 501 is decreased to increase the frequency or increase the resolution. The increase in resolution can enable identification of colors used in small areas, colors that could be useful as highlights. For example, the red 503 becomes visible at a higher resolution, and the skin colors 505 play a more dominant role in the overall color balance of the photograph 205.

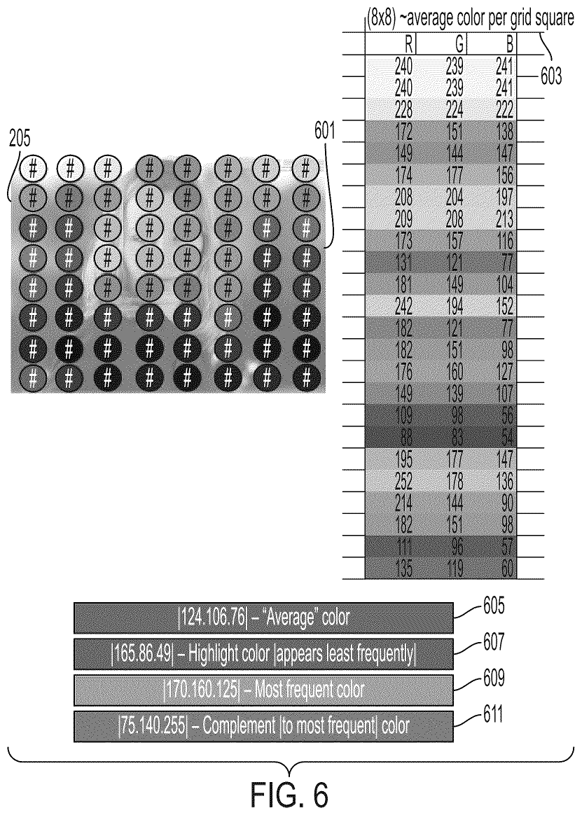

Referring now to FIG. 6, the grid 601 includes sixty-four grid elements. Selecting a grid size enables optimization for different types of photographs, for example, portraits or action shots. The grid element average colors are broken down in a table 603 that provides, for example, red, green, and blue color components, the average red, green, and blue color values over the photograph 205. The average color 605, the highlight color 607 that appears less frequently, the color 609 that appears most frequently, and the complement 611 to the color that appears most frequently in the photograph 205 are shown for the higher resolution grid.

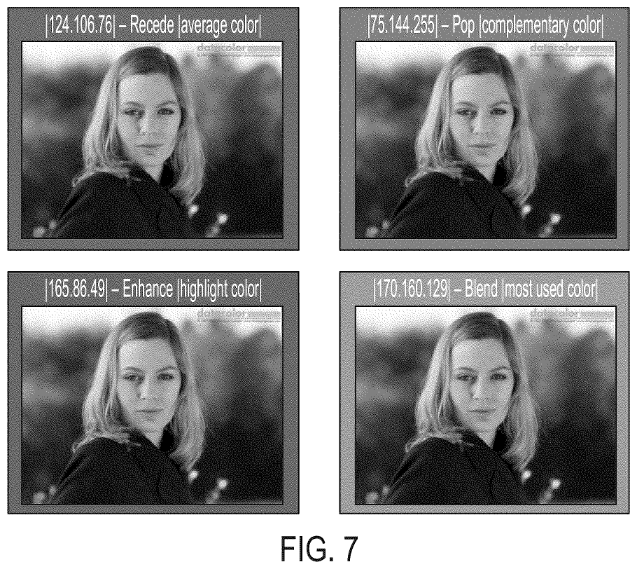

Referring now to FIG. 7, the impacts of adding borders of colors relative to the image when using a higher resolution grid are shown. These images can be compared to the images in FIG. 4.

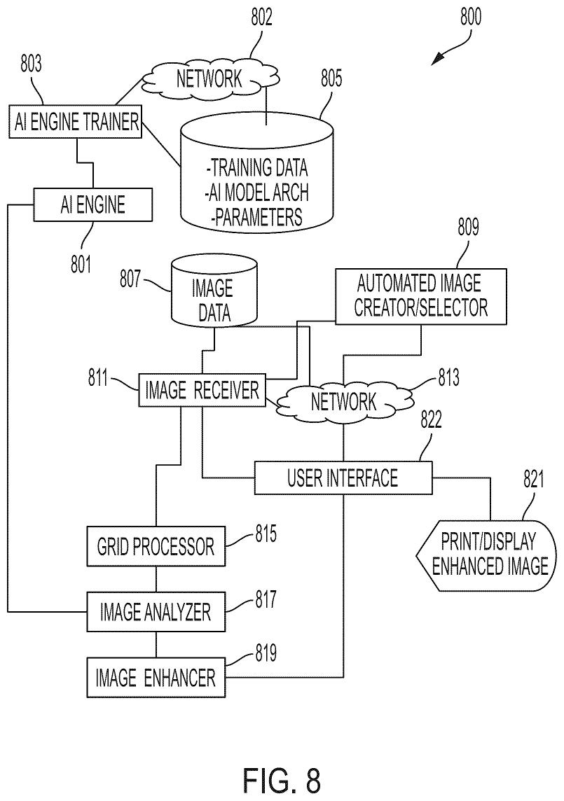

Referring now to FIG. 8, a schematic block diagram of a system 800 for analyzing photographs, suggesting characteristic such as, for example, color palettes or themes, and enhancing the photographs for use in producing a customized design is shown. System 800 includes, but is not limited to including, an AI engine trainer 803. The AI engine trainer 803 receives information from a database 805 that can include, but is not limited to including, model training data, model architecture selection(s), and parameters. The AI engine trainer 803 can receive at least some of the information to generate the AI engine 801 directly from a user, from default values, and/or from dynamically-generated values. Any of this information can also be supplied by devices that are remote to the AI engine trainer 803 through the network 802. In some configurations, the model training data are labeled and prepared to guide the selected AI model's learning process. The training data can include examples of the problem to be solved. Input data are labeled with the correct answer or category, are free of errors and inconsistencies, and provide examples so that the AI engine can generalize to new situations. The model architecture can include, for example, but not limited to, a machine learning model, a rule-based system, an expert system, a neural network, a decision tree, a linear regression model, and a neural network. Parameters can include, but are not limited to including, settings that control the training process, target variables, and outcomes. In some configurations, the AI engine trainer 803 trains the AI engine 801 to identify image elements in the grid cells in the image, determine the characteristics of the identified image elements, select enhancements to the image based on the characteristics, and filter the enhancements based on the identified image elements. The AI engine 801 can be trained to perform other or fewer tasks and in any order.

Continuing to refer to FIG. 8, system 800 can include an image receiver 811. The image receiver 811 can receive images from, for example, but not limited to, a user interface 822, a database 807 of image data, and/or an automated image creator/selector 809. The user interface 822 can include, but is not limited to including, devices such as scanners or cell phones that can receive an electronic image from a printed image such as a photograph. The database 807 of images could be stored on a cell phone or a disk or USB storage device. The automated image creator/selector 809 can provide images whose characteristics are selected by the user. For example, if the user desires to include images with characteristics such as the same colors, dates, themes, or subject, the automated image creator/selector 809 can filter existing images for such characteristics. Input to the image receiver 811 can be provided directly from the user interface 822, the automated image creator/selector 809, and/or the database 807 of image data, or the input can be transmitted from a remote location(s) through the network 813 to the image receiver 811. The image receiver 811 can provide the received image(s) and possibly a chosen resolution to the grid processor 815.

Continuing to refer to FIG. 8, the grid processor 815 either receives a resolution or otherwise determines the resolution, for example, from a default value, from other resolutions selected by a user, or from characteristics of the image itself, for example, how clear the image is. The grid processor 815 “places” a grid of the chosen or determined resolution upon the image and prepares the image for further analysis. Such preparation can include removing extraneous marks from the image, for example.

Continuing to refer to FIG. 8, system 800 can include an image analyzer 817. The image analyzer 817 accesses the previously-trained AI engine 801 and the prepared image from the grid processor 815 to apply the AI engine 801 to the prepared image. As described herein, the AI engine identifies image elements in the grid cells in the image, determines the characteristics of the identified image elements, selects enhancements to the image based on the characteristics, and filters the enhancements based on the identified image elements. For example, if the characteristic is color, the enhancements might include background colors or frame colors that would enhance the image. These possible enhancements are provided to the image analyzer 817. The image analyzer 817 receives the results, i.e. the filtered enhancements, and provides the list of filtered enhancements to the image enhancer 819 which provides the options to, for example, but not limited to, the user interface 822. The image enhancer 819 receives a selection(s) of the enhancement and applies the selection to the image. The image enhancer 819 can provide the list of enhancements to a user or an automated selection application, for example, or can apply a default process to select a desire enhancement(s). The user interface 822 can provide images to an output device such as a printer and/or display 821 that can print/display the enhanced image.

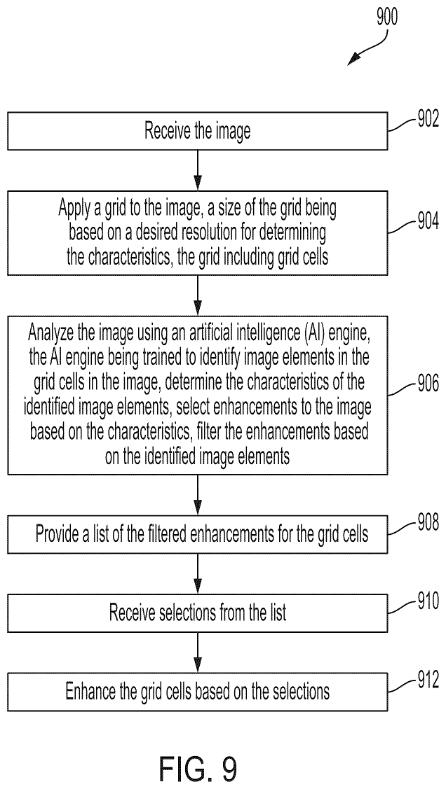

Referring now to FIG. 9, method 900 for enhancing characteristics associated with an image can include, but is not limited to including, receiving 902 the image, and applying 904 a grid to the image. The size of the grid can be based on a chosen resolution for determining the characteristics. Method 900 can include analyzing 906 the image using an artificial intelligence (AI) engine. The AI engine being trained to identify image elements in the grid cells in the image, determine the characteristics of the identified image elements, select enhancements to the image based on the characteristics, and filter the enhancements based on the identified image elements. Method 900 can include providing 908 a list of the filtered enhancements for the grid cells, receiving 910 selections from the list, and enhancing 912 the grid cells based on the selections.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof.

Note that throughout the discussion herein, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Unless specifically stated otherwise, as apparent from the discussion herein, it is appreciated that throughout the description, discussions utilizing terms such as receiving, scanning, identifying, extracting, adding, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

The terminology used herein is for the purpose of describing particular embodiments only and is not intended to be limiting of the disclosure. It will be appreciated that several of the above disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for enhancing characteristics associated with an image comprising:
receiving the image;
applying a grid to the image, a size of the grid being based on a chosen resolution for determining the characteristics, the grid including grid cells;
analyzing the image using an artificial intelligence (AI) engine, the AI engine being trained to:
identify image elements in the grid cells in the image;
determine the characteristics of the identified image elements;
select enhancements to the image based on the characteristics;
filter the enhancements based on the identified image elements;
providing a list of the filtered enhancements for the grid cells;
receiving selections from the list; and
enhancing the grid cells based on the selections.

2. The method of claim 1, wherein the enhancements comprise:
one or more of color, background, or graphics.

3. The method of claim 2, wherein the color is chosen from a color palette comprising:
elemental, advancing, complementary, recede, tonal theme match, fluorescent and shiny.

4. The method of claim 3, further comprising:
using elements of color theory to suggest the color palette.

5. The method of claim 4, wherein using the elements that are dominant in the image to suggest the color palette.

6. The method of claim 4, further comprising:
using the elements that are opposite of prominent colors in the image to suggest the color palette.

7. The method of claim 1, wherein the image comprises:
a set of the images.

8. The method of claim 1, wherein the AI engine is trained to:
recognize an occasion.

9. The method of claim 1, further comprising:
selecting the chosen resolution using a slider.

10. A computer system for enhancing characteristics associated with an image comprising:
a hardware processor; and
a non-volatile storage medium storing instructions that when executed by the hardware processor perform operations comprising:
receiving the image;
applying a grid to the image, a size of the grid being based on a chosen resolution for determining the characteristics, the grid including grid cells;
analyzing the image using an artificial intelligence (AI) engine, the AI engine being trained to:
identify image elements in the grid cells in the image;
determine the characteristics of the identified image elements;
select enhancements to the image based on the characteristics;
filter the enhancements based on the identified image elements;
providing a list of the filtered enhancements for the grid cells;
receiving selections from the list; and
enhancing the grid cells based on the selections.

11. The computer system of claim 10, wherein the enhancements comprise:
one or more of color, background, or graphics.

12. The computer system of claim 11, wherein the color is chosen from a color palette comprising:
elemental, advancing, complementary, recede, tonal theme match, fluorescent and shiny.

13. The computer system of claim 12, wherein the operations further comprise:
using elements of color theory to suggest the color palette.

14. The computer system of claim 12, wherein the operations further comprise:
using the elements that are dominant in the image to suggest the color palette.

15. The computer system of claim 14, wherein the operations further comprise:
using the elements that are opposite of prominent colors in the image to suggest the color palette.

16. The computer system of claim 10, wherein the image comprises:
a set of the images.

17. The computer system of claim 10, wherein the AI engine is trained to:
recognize an occasion.

18. The computer system of claim 11, wherein the operations further comprise:
selecting the chosen resolution using a slider.

19. A computer program product for enhancing characteristics associated with an image, the computer program product comprising a computer readable storage medium having program instructions embodied therewith, the program instructions executable by a computing device to cause the computing device to perform operations comprising:
receiving the image;
applying a grid to the image, a size of the grid being based on a chosen resolution for determining the characteristics, the grid including grid cells;
analyzing the image using an artificial intelligence (AI) engine, the AI engine being trained to:
identify image elements in the grid cells in the image;
determine the characteristics of the identified image elements;
select enhancements to the image based on the characteristics;
filter the enhancements based on the identified image elements;
providing a list of the filtered enhancements for the grid cells;
receiving selections from the list; and
enhancing the grid cells based on the selections.

20. The computer program product of claim 19, wherein:
the image includes a set of the images, and
the AI engine is trained to recognize an occasion.
